(19) United States
(12) Patent Application Publication
(10) Pub. No.: US 2023/0025929 A1
(43) Pub. Date: Jan. 26, 2023

(54) Protective Varnish, in Particular for Security Documents

(71) Applicant: OBERTHUR FIDUCIAIRE SAS, PARIS (FR)

(72) Inventors: Henri ROSSET, LE PIN (FR); Marjory LE BERRE, VERN SUR SEICHE (FR)

(21) Appl. No.: 17/786,736

(22) PCT Filed: Dec. 18, 2020
(86) PCT No.: PCT/EP2020/086958

§ 371 Date: Jun. 17, 2022

(30) Foreign Application Priority Data
Dec. 19, 2019 (FR) 1914829

(51) Int. Cl. C09D 5/14; C09D 7/61; C09D 133/08; C08K 3/40; C09D 163/00; C09D 7/40; C08K 3/08; C08K 5/205

(52) U.S. Cl. CPC C09D 5/14; C09D 7/61; C09D 133/08; C08K 3/40; C09D 163/00; C09D 7/66; C08K 3/08; C08K 5/205; C08K 2003/0806

(57) ABSTRACT

The present invention mainly relates to a protective varnish hardenable by radiation comprising at least one compound hardenable by cationic or radical means and at least one metal selected from silver, copper, zinc and mixtures thereof, characterized in that said metal is in the zero oxidation state and in a supported particulate form.

### TECHNICAL FIELD

The present invention relates to the field of security documents and more particularly banknotes.

It also relates to the field of varnishes and in particular that of overprint varnishes that make it possible to endow banknotes or security documents with an enhanced level of durability by reinforcing the resistance to soiling.

More particularly it relates to a varnish formulation that makes it possible to confer, besides the basic property of reinforcing resistance to soiling, resistance to microscopic soiling and more particularly protection against bacteria, microscopic fungi, in particular yeasts, and viruses.

### PRIOR ART

The banknote is one of the information documents the most exchanged in the world. Repeated exchanges from hand to hand, the usages and environmental conditions of their circulation have an influence on their physical degradation, and heavily used banknotes are often very dirty or even contaminated microbiologically. Now, excessive soiling impairs the visibility of the authentication marks of the banknote, which obliges the central banks to withdraw the banknotes from circulation and reissue cleaner banknotes. One of the solutions envisaged for reducing the frequency of renewal consists of applying, to the surface of the printed banknote, once most of the printing steps have been carried out, a varnish, generally an overprint varnish, which makes it possible to endow the banknote with enhanced resistance to soiling. However, this solution is insufficient for effectively combating microscopic soiling and providing protection against microbes. Now, numerous studies have shown that banknotes in circulation, owing to handling thereof and exchanges from hand to hand, are carriers of microbes, sometimes pathogenic, and in particular bacteria, microscopic fungi, in particular yeasts and viruses. Furthermore, the presence of moulds may degrade cellulosic substrates.

There is therefore still a need for an effective means for endowing banknotes with resistance to soiling combined with effective antibacterial, antifungal and antiviral protection.

Certainly, solutions already exist that make it possible to impart antimicrobial properties to banknote substrates (FR 2 945 180 and FR 2 967 074). Unfortunately, the solutions currently available essentially require antimicrobial solutions based on the combination of biocidal active agents formulated in an aqueous medium, the active agents themselves often being in an aqueous dispersion or emulsion. Now, formulation in matrices of crosslinking resins, in particular as described in patent EP 2 761 084, does not tolerate aqueous compounds.

Moreover, hardening of the applied varnish generally requires a procedure for crosslinking under UV that stipulates irradiation of the coated substrate under high-intensity UV. Now, the antimicrobial active agents used must not be degraded during this step of the printing-varnishing process. They must not be photosensitive.

Moreover, the distribution of the antimicrobial active agents used within the varnish film must be very uniform, sufficiently for the surface interface of the varnish printed substrate, i.e. the outer surface layer of the document, to have sufficient biocidal activity.

The present invention aims precisely to propose a new varnish, in particular an overprint varnish, meeting all of these requirements.

### DISCLOSURE OF THE INVENTION

Thus, the present invention mainly relates to a protective varnish hardenable by radiation, in particular UV, comprising at least one compound hardenable by cationic or radical means and at least one metal selected from silver, copper, zinc and mixtures thereof, characterized in that said metal is in the zero oxidation state and in a supported particulate form.

A varnish according to the invention additionally contains at least one fungicide.

The invention therefore relates quite particularly to a protective varnish hardenable by radiation, in particular UV, comprising:
at least one compound hardenable by cationic or radical means,
at least one fungicide comprising at least iodopropynyl butylcarbamate, IPBC, and
at least one metal selected from silver, copper, zinc and mixtures thereof, characterized in that said metal is in the zero oxidation state and in a supported particulate form.

In particular, the varnish possesses biocidal activity and in particular at least bactericidal or bacteriostatic activity, preferably at least bactericidal. More generally, the varnish possesses bactericidal, bacteriostatic and/or virucidal activity, preferably bactericidal and virucidal.

According to a preferred variant, the metal in the zero oxidation state is supported by an inorganic particulate material and preferably a particulate phosphate glass.

According to another preferred variant, the metal comprises at least silver.

As is clear from the examples given hereunder, the inventors have found that the supported metals of degree zero, according to the invention, do not interfere with the UV irradiation process required for hardening the varnish.

They have noted, moreover, that a varnish incorporating these materials still possesses the expected, or even improved, properties of durability, in particular the antisoiling property, and may remain transparent.

Finally, the inventors found, against all expectations, that these metals of degree zero may generate, in such an environment and in contact with ambient moisture, the ionic metallic species endowed with the required bactericidal activity.

Furthermore, as demonstrated in the examples, combining IPBC with this metal in the zero oxidation state and in a supported particulate form makes it possible, advantageously, to improve the antimicrobial properties of a varnish.

The invention also relates to an object coated on all or part of one of its outer faces with a hardened varnish deposit formed from a hardenable varnish according to the invention. Said object is in particular intended to be touched or handled. It is for example a handle, a button, a touch screen, packaging, an information carrier, in particular a security document or element and preferably a banknote. Said object consists for example of a material selected from a sheet of glass, paper, cardboard, plastic, a textile, an optical structure consisting in particular of a layer or a combination of layers of functional resins.

The invention relates in particular to a security element or document, for example made of paper or plastic, coated on all or part of one of its outer faces with a hardened varnish deposit formed from a hardenable varnish according to the invention.

The invention preferably relates to a security document coated on all or part of one of its outer faces with a hardened varnish deposit formed from a hardenable varnish according to the invention.

More particularly, the security document is surface-treated, on at least one of its faces, with a hardened varnish film formed from said hardenable varnish according to the invention.

According to a preferred variant, this document incorporates one or more security elements and is advantageously a banknote.

The invention also relates to a method of making such an object, comprising at least the steps consisting of
providing said object,
bringing the surface to be treated of said object into contact with a varnish according to the invention, in effective conditions for forming a hardenable varnish deposit on said surface and
exposing said deposit to radiation for hardening said deposit.

The invention relates more particularly to a method of making a security document of this kind comprising at least the steps consisting of
providing said security document,
bringing the surface to be treated of said document into contact with a varnish according to the invention, in effective conditions for forming a hardenable varnish deposit on said surface and
exposing said deposit to radiation for hardening said deposit.

The bringing of the surface to be treated of said object, in particular security document, into contact with the varnish according to the invention may be carried out by a printing process, in particular flexographic, gravure printing, or serigraphic, by spraying, by application by brush or by any other coating process.

Moreover, the invention relates to the use of a varnish according to the invention for producing a protective coating or a protective layer on a security document and preferably a banknote.

It further relates to the use of a varnish according to the invention for improving the resistance to soiling of a security document and preferably a banknote.

It also relates to the use of a varnish according to the invention for imparting antimicrobial properties to a security document and preferably a banknote.

### DETAILED DESCRIPTION

### Supported Metal of Oxidation State Zero

In the sense of the invention, a metal of oxidation state zero is a metal whose atoms are in a non-ionic form. In the present description, the expressions “zero metal”, “metal” and “metal of oxidation state zero” will be used for denoting this unoxidized state of metal.

As stated above, this metal is selected from silver, zinc, copper and mixtures thereof.

According to a preferred variant, the zero metal comprises at least silver and in particular consists of silver.

In the sense of the invention, the expression “in a supported particulate form” signifies that the metal is supported by an inorganic particulate material. More particularly, the metal is immobilized at the surface and, if applicable, in the depth of this material. This material may in particular represent a matrix in which the zero metal is dispersed.

The inorganic material laden with zero metal may be selected from zeolites and glasses, in particular phosphate glasses.

Preferably the material is a glass and more particularly a phosphate glass. Phosphate glass advantageously possesses great stability during a UV crosslinking process.

The sufficiently small particle size, namely on the scale of about ten microns, of the inorganic material laden or doped with zero metal and its intrinsically transparent nature allow the hardened varnish film to retain its transparency and ensure uniform antibacterial protection. Advantageously, in the case of an overprint varnish and as demonstrated in the examples given hereunder, no change is found in the print reproduction and sheen of the banknote. It is in fact known that automatic sorting machines (BPS) for banknotes are “disturbed” by excessive sheen.

The particle size of the material laden or doped with zero metal is thus preferably less than 10 μm and preferably less than 5 μm. The particle size may in particular be measured by SEM imaging or by DLS (dynamic light scattering). The particle size may more particularly be defined by the diameter D98, i.e. the diameter such that 98% of the particles by weight have a size smaller than said diameter.

The loading rate of the material with metal of oxidation state zero varies from 0.5% to 3%, in particular from 1.0% to 2.5%, by weight relative to its total laden weight.

According to one embodiment, the varnish may also contain other mineral particles whose function may in particular be to adjust the level of sheen of the finished varnish film, in particular silica particles. This is quite particularly relevant in the context of overprint varnishes.

As demonstrated by the examples given hereunder, a hardened varnish containing particles laden with zero metal according to the invention and IPBC displays the expected bactericidal and virucidal properties.

According to a preferred variant, the varnish contains metallic silver supported on a particulate material of glass and preferably of phosphate glass.

More precisely, the metallic silver is in the form of particles of silver in a matrix of phosphate glass. This matrix has the advantage of being permeable to silver ions Ag⁺ and therefore of allowing passage/mobility of the silver ions Ag⁺.

These Ag⁺ ions that possess bactericidal activity are generated by bringing the silver of oxidation state zero, dispersed in the varnish, into contact with the ambient moisture or during contamination, for example by droplets in particular from expectoration.

A material of this type is in particular marketed under the name Ultrafresh CA16 of the company Thomson Research Associates Inc.

### Varnish

The term “protective varnish” denotes a varnish useful for imparting resistance to soiling advantageously combined with antimicrobial protection to a security document on the surface of which it is applied.

In the sense of the invention, the term antimicrobial describes biocidal activity in particular bactericidal, fungicidal, in particular levuricidal, virucidal and/or algicidal activity, i.e. which kills the microorganism in question, but also bacteriostatic and/or fungistatic activity, i.e. which inhibits the growth of bacteria and microscopic fungi.

The expression “varnish hardenable by radiation” covers, in the sense of the invention, varnishes that solidify under Infrared/Hot Air and UV drying.

For this purpose, the varnish considered according to the invention comprises one or more hardenable compounds.

In the sense of the invention, a hardenable compound is a compound able to polymerize, crosslink or undergo polycondensation if applicable with other compounds, in response to a stimulus, in this case heating by infrared or UV irradiation and if necessary in the presence of an auxiliary compound called an initiator, and thus form irreversibly a film that is solid in ambient conditions (room temperature, irradiation by daylight, etc.).

Advantageously, it is a varnish hardenable by UV-visible radiation. In other words it solidifies under UV drying.

For example, acrylic varnishes, varnishes comprising an epoxide base, or varnishes comprising an acrylate base are particularly suitable. It is preferably varnish comprising an acrylate base.

It may in particular be a varnish based on monomers of the polyalkyl acrylate class, a varnish based on an unsaturated acrylic resin or a varnish based on monomers of the cycloaliphatic epoxide class. The last-mentioned class polymerizes, giving a polyepoxide matrix with the aid of initiators, in particular photoinitiators, such as onium salts activated under ultraviolet.

These compounds may moreover be combined, if necessary, with a free-radical photoinitiator such as for example an onium salt in particular such as sulfonium cations and anions, substituted if applicable.

Thus, the varnish may further comprise a free-radical photoinitiator.

The hardenable varnish according to the invention is thus preferably the precursor of a hardened varnish of the polyepoxide or polyacrylate type, and more preferably of the polyepoxide type.

As an illustration of these varnishes, we may mention for example the polyepoxide varnish marketed under the name “Sicpaprotect” (reference 889368 for paper substrates or 889354 for polymer substrates) from Sicpa, and the polyacrylate varnishes marketed under the name “Wessco Protector 36.389.19” from Schmidt Rhyner.

According to a preferred variant, the varnish according to the invention is a cationic varnish.

According to another preferred variant, the varnish according to the invention is an overprint varnish useful in particular for security documents.

The varnishes according to the invention are advantageously fluid for easily forming films by application on the surfaces to be treated.

For example, a varnish according to the invention may be deposited on the surface of a substrate by any suitable method and for example by methods of flexographic printing, gravure printing or screen printing or even methods of air knife coating, curtain coating or coating by roller. The viscosity of the varnish according to the invention may be adjusted via the nature and/or amount of the solvent medium in which the hardenable compound or compounds is/are formulated.

Thus, they may have a viscosity between 30 mPa·s and 40 Pa·s, in particular between 50 mPa·s and 20 Pa·s, measured at ambient temperature and pressure.

The viscosities of the compositions may be measured by conventional methods. Selection of the appropriate method of measurement as well as measuring equipment in particular with regard to the scale of viscosity of the composition in question is clearly within the competence of a person skilled in the art.

The varnish in hardened form may be completely transparent. This pseudo-invisibility of the varnish applied is particularly advantageous, for obvious reasons. In particular, the varnishes according to the invention prove particularly advantageous for constituting overprint varnishes of information carriers such as banknotes. They do not impair the visibility of the security elements incorporated in these banknotes.

A varnish according to the invention may comprise from 0.001% to 0.2 wt %, preferably from 0.003% to 0.015%, and more preferably less than 0.01%, or even less than 0.008% of metal with oxidation state equal to zero relative to its total weight.

The varnish according to the invention contains at least some iodopropynyl butylcarbamate, IPBC.

As an illustration of IPBC, we may mention for example the product marketed by the company Troy Chemical Company under the name Fungitrol C450.

In particular, a varnish according to the invention may comprise from 0.1% to 5.0%, preferably from 1% to 4%, and more preferably from 1.5% to 3.5%, by weight of IPBC relative to its total weight.

Advantageously, the metal in the zero oxidation state and the IPBC are used in a metal/IPBC weight ratio ranging from 0.0007 to 0.01, preferably from 0.0008 to 0.007, preferably from 0.001 to 0.005, and more preferably from 0.0015 to 0.004, or even from 0.0017 to 0.0034.

Besides the supported zero metal and the IPBC, the varnish may advantageously comprise auxiliary antimicrobial agents provided that they are compatible with a formulation in a non-aqueous medium and irradiation, in particular UV.

Advantageously, a varnish according to the invention additionally contains at least one fungicide different from IPBC.

According to one variant, the composition according to the invention contains at least one fungistatic and/or fungicidal agent selected from the compounds based on isothiazoline or isothiazoline derivatives, zeolite, zinc and triclosan.

Preferably, the varnish according to the invention contains, as fungistatic and/or fungicidal agent, at least one compound selected from p-((diiodomethyl)sulfonyl) toluene and methyl-1H-benzimidazol-2-ylcarbamate.

A varnish according to the invention may comprise from 0.1% to 2.0%, preferably from 0.5% to 1.5%, by weight of fungicide(s) relative to its total weight. Advantageously, a varnish according to the invention may comprise from 0.1% to 5.0%, preferably from 1% to 4%, and more preferably from 1.5% to 3.5%, by weight of fungicide(s) relative to its total weight.

### Security Document

As stated above, the varnish according to the invention is quite particularly suitable for forming a protective and in particular antimicrobial coating on the surface of security documents intended to be handled relatively frequently.

In the sense of the invention, a “security document intended to be handled relatively frequently” is a substrate handled at least twice manually by one and the same individual or at least two different individuals. Manual handling may consist of at least one contact, for example taking hold of, by at least part of a hand. The security documents considered according to the invention are intended moreover for use in ambient atmosphere and not for use in a liquid medium.

The security document intended to be handled relatively frequently according to the invention may in particular be based on papermaking fibres known by a person skilled in the art, for example cellulosic fibres (in particular cotton fibres) and/or natural organic fibres other than cellulosic, and/or synthetic fibres, for example such as polyester or polyamide fibres, and/or optionally mineral fibres, for example such as glass fibres.

According to one embodiment, the security document is based on materials, in particular cellulosic fibres, and in particular paper.

According to another embodiment, the security document is based on natural organic fibres other than cellulosic.

According to yet another embodiment, the security document is based on plastic materials, and in particular synthetic fibres or a plastic sheet.

The security document may also be a plastic film, and in particular a biaxially stretched film based on polyethylene or polypropylene. It may for example be a saturated polyester such as poly(ethylene terephthalate). It may also be a film of polycarbonate or polyvinyl chloride (PVC).

The security document may also be multilayer, in particular laminated or pasted.

According to a preferred embodiment, the security document according to the invention incorporates at least one security element allowing authentication of said sheet.

In particular, said security element is selected from visual devices, in particular optically variable devices, called OVDs, holograms, lenticular devices, elements with an interference effect, in particular iridescent elements, liquid crystals, magnetically orientable effect pigments and multilayer interference structures. These optically variable devices may be present on security threads incorporated in the document or on strips or patches affixed or printed on the document.

As another visual security element, we may also mention watermarks produced during a banknote manufacturing process.

In particular, said security element may be selected from the so-called luminescent elements, detectable under UV or under IR, and these luminescent elements may be in the form of particles, Fibrettes, tags, security threads of strips or patches affixed or printed on the security document.

In particular, said security element may be selected from the elements detectable automatically, in particular optically or magnetically, these detectable elements commonly called markers or taggants being incorporated in the fibrous substrate or in visual or luminescent security elements.

A security document according to the invention may also comprise a radio frequency identification device, called RFID, also supplying a function of identification and traceability to the security sheet.

The security document according to the invention may thus be a passport, a banknote, an identity card, a driving license, an access card, a loyalty card, a photocopying card, a canteen card, a playing card, a collection card, a means of payment, in particular a payment card.

Advantageously, the security document considered according to the invention is a security sheet, in particular printed, which incorporates at least one security element allowing authentication of the sheet and is preferably a banknote.

The security document according to the invention is coated on all or part of one of its faces, with a hardened varnish deposit formed from a hardenable varnish according to the invention.

In particular, the security document may comprise from 0.25 ppm to 3.1 ppm of metal derived from the metal of oxidation state zero present in the varnish relative to its total weight. It may also comprise from 100 ppm to 1200 ppm of IPBC relative to its total weight.

More particularly, the security document according to the invention is surface-treated, on at least one of its faces, with a hardened varnish film formed from a hardenable varnish according to the invention.

For this purpose, the security document face is brought into contact with a hardenable varnish according to the invention in effective conditions for forming a deposit, preferably in the form of a film, of hardenable varnish and the deposit thus formed is exposed to radiation to harden said varnish.

The contacting of the varnish with the surface to be treated of the document signifies that varnish is deposited on at least part of the surface of the document to be treated. Formation of this deposit of varnish is carried out according to usual conditions. As an illustration of the possible manners of deposition, we may in particular mention the printing processes, in particular flexographic, gravure printing, or serigraphic, by spraying, by application by brush or by any other coating process.

The varnish is hardened by drying the hardenable varnish.

This drying may be carried out by exposure to infrared or UV irradiation using a suitable lamp.

The deposit may be formed by application of about 0.5 to 5 g/m², in particular from 1.5 to 2.5 g/m², or even of about 1.5 to 2 g/m², of hardenable varnish.

As is clear from the examples given hereunder, the varnish film advantageously makes it possible to endow the corresponding security document with antibacterial, antifungal and antiviral properties without altering the appearance of the varnish film or its properties of reinforcement of durability.

The antimicrobial activities may in particular be evaluated by the tests of the antifungal, anti-yeast, antibacterial and antiviral properties detailed in the section hereunder titled material and methods.

Thus, a banknote coated with a hardened varnish derived from a hardenable varnish according to the invention possesses enhanced resistance to soiling compared to that of an untreated banknote.

The use of a varnish according to the invention makes it possible to improve the barrier properties including quite particularly the resistance to soiling of a security document, in particular a banknote, i.e. this use may in particular prevent or reduce the formation and/or deposition of dirt.

The barrier properties, including quite particularly the resistance to soiling, can be evaluated by the Cobb, Fritsch and Kit tests detailed in the Material and Methods section.

The examples and figures given hereunder are presented for purposes of illustration and do not limit the scope of the invention.

### Material and Methods

The information carrier is a paper substrate for banknotes based on cotton fibres (=“vellum”).

### The Varnishing Operations

They are carried out recto/verso (R°/V°) with a group 1 flexographic machine with an in-line UV drying unit, on a vellum paper substrate (100% cotton) calendered on 1 face (i.e. provided with an inkless dry stamp produced by the copperplate printing process). An Anilox value of 6 cm³/m² and a flexographic plate with a solid tone are used for flexographic printing unless stated otherwise.

The Anilox value corresponds to the surface volume of ink or of varnish that the flexographic printing cylinder called “cylinder Anilox” is able to transfer to the flexographic printing plate.

Test of Antifungal Properties

They are characterized by means of fungistatic control according to textile standard AATCC-30 test 3 with Aspergillus niger van Thiegem (DSM 1957), and according to standard AFNOR NFX41517 with a mixture of 10 strains and a contact time of 7 days and/or 14 days.

Test of Anti-Yeast Properties

They are characterized by means of the control according to standard NF ISO 13629-2:2014 with Candida albicans ATCC10231.

Test of Antibacterial Properties

They are characterized by means of the antibacterial control according to standard NF EN ISO 20743:2013—Textiles, determination of the antibacterial activity of the textile products, transfer method, with the strains Escherichia coli (ATCC 8739) representative of the Gram-negative bacteria and Staphylococcus aureus (ATCC 6538) representative of the Gram-positive bacteria.

Test of Antiviral Properties

Unless stated otherwise, they are characterized by means of the antiviral control according to standard ASTM 1053-97 with a contact time of 5 hours with the strain Coronavirus 0C43 (ATCC VR-1558).

Other viral strains may be used, in particular Influenza A H1N1 (ATCC VR1469) or Coronavirus HcoV-229^{E}.

Tests for Evaluating Barrier Properties

They are characterized by means of the 3 tests described below.

Cobb: The Cobb test carried out according to standard ISO 535:2014 makes it possible to characterize the water resistance of the sample.

Fritsch: The resistance to soiling was tested according to the so-called “dry soil” test (Fritsch test). It is a vibrating apparatus (“Analysette 3 Pro” from the Fritsch company) where small glass beads spread and encrust, on a paper test specimen, a soiling composition based on sand, peat, activated carbon, flour, and glycerin mono-oleate (fat present in sebum). The test takes 15 minutes. The luminance of a zone determined at the beginning, in particular lacking printing, is measured several times before and after exposure to the soiling composition. The difference obtained or ΔL* makes it possible to characterize attachment of the dirt to the banknote: the lower its value, the better the resistance to dry soiling.

Test kit: The test kit prepared according to standard TAPPI T559 CM-12 makes it possible to evaluate the oil resistance of the sample.

Test of Print Reproduction Including Sheen

Sheen is measured at an angle of 60° according to standard ISO 2813.

Colour Rendering Test

The colour (L*, a* and b*) is measured according to standard NF EN ISO/CIE 11664-4 with the D65 illuminant and an angle of 10°.

### Example 1

A composition of cationic UV varnish (viscosity of about 60 s DIN 4) is prepared from 99.7% of a reference cationic UV varnish (hereinafter “varnish V1”) marketed under reference 889 368 by the company Sicpa and 0.3% of Ultrafresh CA16 from the company Thomson Research Associates Inc.

This composition is tested on substrates of the vellum type laminated on 1 face (=TD 1 face). Calendered face=recto (R°) and uncalendered face=verso (V°).

For purposes of comparison, varnish V1 (100%) is also tested.

The two varnishes are applied with an Anilox of 6 cm³/m².

The coatings formed are tested for their resistance to water, dirt and oil according to the protocols described in the Material and Methods section.

The results are presented in Table 1 hereunder.

TABLE 1

| | | | Untreated | Varnish from |
|---|---|---|---|---|
| | | | varnish | Example 1 |
| Cobb | Face with | Mean value | 30.4 | 37.4 |
| | TD | SD | 2.0 | 1.0 |
| | Face without | Mean value | 41.1 | 40.8 |
| | TD | SD | 0.8 | 1.1 |
| Fritsch | Face with | Mean value | −4.1 | −4.1 |
| | TD | SD | 0.6 | 0.4 |
| | Face without | Mean value | −9.6 | −8.8 |
| | TD | SD | 2.3 | 1.4 |
| Test kit | Face with TD | Result | 1 | 1 |
| | Face without | Result | 1 | 1 |
| | TD | | | |

SD = standard deviation

These results show that adding the biocide advantageously does not have a significant impact on the properties of resistance to water, dirt and oil.

### Example 2

### Preparation of a Composition According to the Invention Additionally Incorporating Fungitrol

A varnish of the following formula
98.7% of varnish V1.
1% of Fungitrol C450 (iodopropynyl butylcarbamate, IPBC)
0.3% of Ultrafresh CA16 is prepared according to the protocol detailed below:

For 1 kg of end product: in a beaker, under a hood, incorporate 10 g of Fungitrol C450 in 987 g of varnish V1. Mix the whole with a laboratory dispersing machine (e.g. dispersing machine made by Dispermill, model Vango 100) with a dispersing disc suitable for the size of the beaker used at a speed of 1000 rpm for 15 minutes. Then incorporate 3 g of Ultrafresh CA 16 in this mixture and stir the whole again with the dispersing machine in the same conditions as for the Fungitrol (1000 rpm—15 minutes). Leave the varnish thus obtained to stand until the air bubbles disappear before use.

### Example 3

### Application of the Composition According to Example 2 and Characterization of the Biocidal Properties and Barrier Properties Including Resistance to Soiling of the Varnish Formed

The varnishes considered (varnish according to the invention from example 2 and CONTROL varnish without Fungitrol or Ultrafresh) are applied with an Anilox of 6 cm³/m² on the same substrate as in example 1.

Tables 2 and 3 report the antifungal properties tested according to the protocols detailed in the Material and Methods section. Four measurements are performed on each face of the samples (recto and verso), or 8 measurements per sample.

The boxes are read as follows
0: no development
1: trace of fungal development
2: slight development (10 to 30% of the surface of the test specimen)
3: moderate development (30 to 60% of the surface of the test specimen)
4: strong development (>60% of the surface of the test specimen)

TABLE 2
Standard AATCC 30 test 3 - After 7 days:

| | | |
|---|---|---|
| Unvarnished | encroachment score | R°: 4 - 4 - 4 - 4/V°: 4 - 4 - 4 - 4 |
| sample | | mean value 8 dishes: 4 |
| | inhibition zone (mm) | no inhibition zone |
| Sample with | encroachment score | R°: 4 - 4 - 4 - 4/V°: 4 - 4 - 4 - 4 |
| CONTROL | | mean value 8 dishes: 4 |
| varnish | inhibition zone (mm) | no inhibition zone |
| Sample with | encroachment score | R°: 0 - 0 - 0 - 0/V°: 0 - 0 - 0 - 0 |
| varnish | | mean value 8 dishes: 0 |
| according to | inhibition zone (mm) | R°: 3 - 3 - 3 - 5/V°: 4 - 4 - 1 - 3 |
| the invention | | mean value: 3.3 mm |

It can thus be seen that the CONTROL varnish does not provide antifungal protection and that conversely the varnish according to the invention is indeed antifungal. The fungicide therefore maintains its activity in the proposed formulation.

TABLE 3
Standard Afnor NFX41517 - After 7 and 14 days:

| | | 7 days | 14 days |
|---|---|---|---|
| Samples with | Encroachment | R°: 4-4-4-3/ | R°: 4-4-4-4/ |
| CONTROL | score | V°: 4-4-4-4 | V°: 4-4-4-4 |
| varnish | | Mean value 8 | Mean value 8 |
| | | dishes: 3.9 | dishes: 4 |
| Samples with | Encroachment | R°: 1-1-1-1/ | R°: 2-3-4-4/ |
| varnish | score | V°: 0-1-1-1 | V°: 2-3-3-0 |
| according to | | Mean value 8 | Mean value 8 |
| the invention | | dishes: 1 | dishes: 2.6 |

This test confirms that the CONTROL varnish does not provide antifungal properties. The varnish according to the invention gives good results after 7 days with only traces of fungal development. After 14 days, the results are also improved relative to the CONTROL varnish.

Table 4 below presents the antibacterial properties tested according to the protocol detailed in the Material and Methods section.

TABLE 4

| | E. coli | | | S. aureus | | |
|---|---|---|---|---|---|---|
| Starting | log 4.14 × 10⁴ = 4.6 | | | log 5.04 × 10⁴ = 4.7 | | |
| concentration | | | | | | |
| of inoculum | | | | | | |
| Concentration | log 7.4 × 10⁷ = 7.9 | | | log 1.02 × 10⁷ = 7 | | |
| of inoculum | | | | | | |
| after 24 h | | | | | | |
| incubation | | | | | | |
| Growth value | 3.3 | | | 2.3 | | |
| | Qty Q of | | | Qty Q of | | |
| | bacteria | | % | bacteria | | % |
| Sample | after 24 h | Log Q | reduction | after 24 h | Log Q | reduction |
| Unvarnished | 4.47 × 10⁷ | 7.7 | 39.6 | 3.3 × 10⁷ | 7.5 | 0 |
| With | 9.28 × 10⁶ | 7 | 87.5 | 2.1 × 10⁶ | 7.3 | 79.4 |
| CONTROL | | | | | | |
| varnish | | | | | | |
| With varnish | 1.19 × 10⁵ | 5.1 | 99.8 | 9.16 × 10³ | 4 | 99.9 |
| according to | | | | | | |
| the invention | | | | | | |

It can be seen that only the substrate with varnish according to the invention displays pronounced bactericidal activity. In fact, the unvarnished substrate gives zero or little protection and the CONTROL varnish substrate displays moderate bacteriostatic protection. The treatment therefore makes it possible to impart effective antibacterial protection.

Table 5 below reports on the barrier properties including resistance to soiling of the varnish according to the invention compared to the CONTROL varnish.

They are tested according to the protocol detailed in the Material and Methods section.

TABLE 5

| | | Cobb (g/m²) | | Fritsch (ΔL) | | Test kit | |
|---|---|---|---|---|---|---|---|
| | | Recto | Verso | Recto | Verso | Recto | Verso |
| CONTROL | Mean | 12.6 | 10 | −6.9 | −14.3 | 1 | 1 |
| varnish | value | | | | | | |
| | Standard | 1.6 | 0.8 | 1.8 | 2.4 | / | / |
| | deviation | | | | | | |
| Varnish | Mean | 8.9 | 10.4 | −3.7 | −10.8 | 1 | 2 |
| according | value | | | | | | |
| to the | Standard | 0.4 | 0.3 | 0.8 | 0.7 | / | / |
| invention | deviation | | | | | | |

The properties of the varnish (resistance to water, dirt and oil) are not degraded by adding Fungitrol and Ultrafresh. In fact, the results for the varnish according to the invention are equivalent or even slightly better than those for the CONTROL varnish.

The following measurements were also carried out to verify that the varnish according to the invention does not alter the print reproduction of the banknote including the sheen of the varnish (and consequently of the varnished banknote).

The results of measurement of sheen are presented in Table 6 below.

TABLE 6

| | | | Varnish according to the invention | |
|---|---|---|---|---|
| | CONTROL varnish | | 0.3% CA16 + 1% Fungitrol | |
| Sheen | Recto | Verso | Recto | Verso |
| Mean value | 10.16 | 4.2 | 10.54 | 4.24 |
| Standard | 0.13 | 0.07 | 0.41 | 0.09 |
| deviation | | | | |

| | | |
|---|---|---|
| Difference relative to the CONTROL | 3.74% | 0.95% |

The differences between the CONTROL varnish and the varnish according to the invention are slight and not significant in view of the standard deviations. The treatment therefore also has the advantage of not affecting the sheen.

The following measurements were also carried out to verify that the varnish according to the invention does not alter the colour rendering. The measurement results are presented in Table 7 below.

TABLE 7

| | Recto | | | | | |
|---|---|---|---|---|---|---|
| | | | | Varnish according | | |
| | | | | to the invention 0.3% | | |
| | CONTROL varnish | | | CA16 + 1% Fungitrol | | |
| Colour | L* | a* | b* | L* | a* | b* |
| Mean value | 92.88 | −0.92 | 4.06 | 92.65 | −0.94 | 4.10 |
| Std. Dev. | 0.61 | 0.03 | 0.11 | 0.01 | 0.01 | 0.05 |
| Difference relative to | | | | −0.25 | 2.55 | 1.07 |
| the CONTROL (%) | | | | | | |
| | Verso | | | | | |
| | | | | Varnish according | | |
| | | | | to the invention 0.3% | | |
| | CONTROL varnish | | | CA16 + 1% Fungitrol | | |
| Colour | L* | a* | b* | L* | a* | b* |
| Mean value | 93.35 | −0.94 | 4.07 | 93.54 | −0.95 | 4.04 |
| Std. Dev. | 0.16 | 0.03 | 0.05 | 0.28 | 0.04 | 0.08 |

| | | | |
|---|---|---|---|
| Difference relative to | 0.21 | 0.35 | −0.66 |
| the CONTROL (%) | | | |

The changes in colour relative to a banknote with the varnish V1 are very slight with the varnish according to the invention and not significant in view of the standard deviations. The treatment therefore also has the advantage of not affecting the colours.

### Example 4: Preparation of a Composition According to the Invention

A varnish of formula F1 as follows
97.7% of varnish V1
2% of Fungitrol C450
0.3% of Ultrafresh CA16
   is prepared according to the protocol detailed in example 2 with in this case 20 g of Fungitrol C450 incorporated in 977 g of varnish V1.

### Example 5: Application of the Composition According to Example 4 and Characterization of the Biocidal and Barrier Properties Including the Resistance to Soiling of the Varnish Formed

The varnishes considered (varnish F1 according to the invention from example 4 and CONTROL varnish) are applied with an Anilox of 6 cm³/m² on the same substrate as in example 1.

Tables 8 and 9 report the antifungal properties tested as in example 3 according to the protocols detailed in the Material and Methods section.

TABLE 8
Standard AATCC 30 test 3 - After 7 days:

| | | |
|---|---|---|
| Unvarnished | Encroachment score | R°: 4 - 4 - 4 - 4/V°: 4 - 4 - 4 - 4 |
| sample | | Mean value 8 dishes: 4 |
| | Inhibition zone (mm) | No inhibition zone |
| Sample with | Encroachment score | R°: 4 - 4 - 4 - 4/V°: 4 - 4 - 4 - 4 |
| CONTROL | | Mean value 8 dishes: 4 |
| varnish | Inhibition zone (mm) | No inhibition zone |
| Sample with | Encroachment score | R°: 0 - 0 - 0 - 0/V°: 0 - 0 - 0 - 0 |
| varnish | | Mean value 8 dishes: 0 |
| according to | Inhibition zone (mm) | R°: 9 - 8 - 9 - 8/V°: 8 - 9 - 7 - 7 |
| the invention | | Mean value: 8 mm |

Just as in example 3, the CONTROL varnish does not provide antifungal protection, contrary to the varnish according to the invention. It can be seen that increasing the amount of IPBC increases the size of the inhibition zone.

TABLE 9
Standard Afnor NFX41517 - After 7 and 14 days:

| | | 7 days | 14 days |
|---|---|---|---|
| Samples with | Encroachment | R°: 4-4-4-3/ | R°: 4-4-4-4/ |
| CONTROL | score | V°: 4-4-4-4 | V°: 4-4-4-4 |
| varnish | | Mean value 8 | Mean value 8 |
| | | dishes: 3.9 | dishes: 4 |
| Samples with | Encroachment | R°: 0-0-0-0/ | R°: 0-0-0-0/ |
| varnish | score | V°: 0-0-0-0 | V°: 2-0-3-0 |
| according to | | Mean value 8 | Mean value 8 |
| the invention | | dishes: 0 | dishes: 0.6 |

Compared to example 3, the results for this varnish F1 are clearly improved relative to a varnish whose IPBC content is lower, with no fungal growth at any of the measurement points after 7 days and at 6 measurement points out of 8 after 14 days.

Table 10 below reports on the anti-yeast properties:

| | Candida albicans | | | |
|---|---|---|---|---|
| | Concentration of the inoculum after 24 h of incubation | | | |
| | Log 2.93 × 10⁶ = 6.47 | | | |
| | Qty of yeasts on | Qty Q of yeasts | Log | % |
| Sample | the sample at T0 | after 24 h | Q | reduction |
| Not varnished | 2.45 × 10⁵ | 3.51 × 10⁷ | 7.55 | 0% |
| With varnish | 1.44 × 10⁵ | 0 | 0* | 100% |
| according to | | | | |
| the invention | | | | |

*When the mean value is equal to 0, arbitrarily the log of the mean value is also equal to 0.

The varnish according to the invention confers a levuricidal property on the sample with 100% mortality after 24 h.

Table 11 below reports on the antibacterial properties tested according to the protocol detailed in the Material and Methods section.

TABLE 11

| | E. coli | | | | S. aureus | | | |
|---|---|---|---|---|---|---|---|---|
| Concentration | log 2.15 × 10⁶ = 6.3 | | | | log 1.13 × 10⁶ = 6.0 | | | |
| of inoculum | | | | | | | | |
| after 24 h | | | | | | | | |
| incubation | | | | | | | | |
| | Qty of | | | | Qty of | | | |
| | bacteria | Qty of | | | bacteria | Qty of | | |
| | on the | bacteria | | | on the | bacteria | | |
| | sample | after | | % | sample | after | | % |
| Sample | at T0 | 24 h | Log Q | reduction | at T0 | 24 h | Log Q | reduction |
| With varnish | 3.29 × 10⁴ | 0 | 0* | 100% | 1.07 × 10⁵ | 0 | 0* | 100% |
| according to | | | | | | | | |
| the invention | | | | | | | | |

*When the mean value is equal to 0, arbitrarily the log of the mean value is also equal to 0.

It can be seen that the substrate with varnish according to the invention displays pronounced bactericidal activity. The treatment therefore makes it possible to confer effective antibacterial protection.

Table 12 below reports on the antiviral properties of the varnish according to the invention and of the CONTROL varnish relative to an unvarnished sample indicated as reference in the table.

The percentage reduction between T0 and T5 h corresponds to the percentage reduction of the viral load after 5 hours of contact time.

The “antiviral activity vs. reference” line corresponds to the reduction of viral load between T0 and T5 h of the sample considered relative to the reference expressed in log. They are tested according to the protocol detailed in the Material and Methods section.

TABLE 12

| | With | With varnish |
|---|---|---|
| | CONTROL | according to |
| | varnish | the invention |
| % viral reduction between T0 and T5 h | 99.8% | >99.999% |
| Antiviral activity vs reference | 0.45 log | 2.79 log |

The varnish according to the invention has an activity that can be considered as virucidal with a percentage reduction almost equal to 100%. The gain relative to the CONTROL varnish is significant with a reduction of the viral load 220 times greater.

Table 13 below reports on the barrier properties including resistance to soiling of the varnish according to the invention compared to the CONTROL varnish.

They are tested according to the protocol detailed in the Material and Methods section.

TABLE 13

| | | Cobb (g/m²) | | Fritsch (ΔL) | | Test kit | |
|---|---|---|---|---|---|---|---|
| | | Recto | Verso | Recto | Verso | Recto | Verso |
| CONTROL | Mean | 14.4 | 38.6 | −8.9 | −11.0 | 3 | 3 |
| varnish | value | | | | | | |
| | Standard | 2.8 | 10.3 | 2.8 | 0.8 | / | / |
| | deviation | | | | | | |
| Varnish | Mean | 19.2 | 38.7 | −9.0 | −13.7 | 3 | 3 |
| according | value | | | | | | |
| to the | Standard | 10.5 | 7.4 | 1.3 | 2.1 | / | / |
| invention | deviation | | | | | | |

The properties of the varnish (resistance to water, dirt and oil) are not degraded by adding Fungitrol and Ultrafresh. In fact, the results for the varnishes according to the invention are very close to those for the CONTROL varnish. The slight differences observed are not significant in view of the standard deviations.

### Example 6

Various formulae of varnish detailed in Table 14 below are prepared according to the protocol described in example 2. The contents are expressed in percentage by weight in the varnish.

The varnishes considered are applied according to the varnishing protocol detailed in the Material and Methods section, on the same substrate as in example 1.

The antiviral activity is tested according to the protocol detailed in the Material and Methods section and reported in Table 14. The results for varnish F1, detailed in example 5, are also included for comparison.

TABLE 14

| | Not | CONTROL | Varnish | Varnish | Control varnish |
|---|---|---|---|---|---|
| | varnished | varnish | F1 | F4 | F5 |
| Fungitrol C450 | — | 0% | 2% | 3% | 2% |
| Ultrafresh CA16 | — | 0% | 0.3% | 0.3% | 0% |
| Varnish V1 | — | 100% | 97.7% | 96.7% | 98% |
| % viral reduction | 99.3% | 99.80% | | | |
| between T0 and T5 h | 99.84% | | >99.999% | | |
| | 98.0% | | | 99.98% | |
| | 98.5% | | | | 99.9% |
| Antiviral activity | — | 0.45 log | 2.79 log | 2.06 log | 1.00 log |
| versus reference | | | | | |

Thus, it can be seen that varnishes F1 and F4 comprising both silver with oxidation state zero in the supported form and IPBC display antiviral activity greater than that of a CONTROL varnish. These varnishes F1 and F4 also display antiviral activity greater than that of varnish F5 devoid of silver in the supported form.

### Example 7

Various varnish formulae detailed in Table 15 below are prepared according to the protocol described in example 2. The contents are expressed in percentage by weight in the varnish. The information carrier is also a paper substrate for banknotes based on cotton fibres, related to the paper substrate used for the preceding examples.

The varnishes considered are applied with an Anilox of 7 cm³/m² on this substrate according to the varnishing protocol detailed in the Material and Methods section.

The antiviral activity is then tested according to the protocol detailed in the Material and Methods section.

TABLE 15

| | Varnish F1 | Varnish F2 |
|---|---|---|
| Fungitrol C450 | 2% | 2% |
| Ultrafresh CA16 | 0.3% | 0.6% |
| Varnish V1 | 97.7% | 97.4% |
| % viral reduction | 99.98% | 99.92% |
| between T0 and T5 h | | |
| Antiviral activity | 1.74 log | 0.63 log |
| versus reference | | |

Comparison of varnishes F1 and F2 shows that the viral reduction and the antiviral activity decreases when the content of silver supported in the varnish and therefore also on the substrate increases.

### Example 8: Application of the Composition According to Example 4 on a Plastic Substrate and Characterization of the Biocidal Properties of the Varnish Formed

A varnish F1′ is prepared like varnish F1 described in example 4 according to the protocol described in example 2, the varnish V1 being replaced by a varnish commercialized under reference 889 354 by the company Sicpa (hereinafter “varnish V1′”). The contents are expressed in percentage by weight in the varnish.

The information carrier is a “Guardian” plastic substrate for banknotes marketed by the company CCL Secure.

The antiviral activities indicated in Table 16 below are characterized by means of the antiviral control according to standard ISO 21702:2019 (measurement of the antiviral activity on plastic surfaces and other non-porous surfaces).

TABLE 16

| | Varnish F1′ | Varnish F1′ |
|---|---|---|
| Fungitrol C450 | 2% | 2% |
| Ultrafresh CA16 | 0.3% | 0.3% |
| Varnish V1′ | 97.7% | 97.7% |
| Viral strain | Coronavirus OC43 | Coronavirus HcoV-229E |
| % viral reduction | 99.89% | 99.87% |
| between T0 and T5 h | | |
| Antiviral activity vs | 1.82 log | 2.4 log |
| reference | | |

In view of the results, antiviral protection of varnish F1 is verified on a plastic substrate.

1-27. (canceled)

28. A protective varnish comprising:
a radiation hardenable compound;
a fungicide comprising iodopropynyl butylcarbamate (IPBC), and
particulates loaded or doped with a metal having a zero oxidation state, the metal selected from silver, copper, zinc, or a combination thereof.

29. The protective varnish of claim 28, wherein the protective varnish has biocidal activity.

30. The protective varnish of claim 28, wherein the particulates comprise an inorganic particulate material.

31. The protective varnish of claim 30, wherein the particulates are loaded with from 0.5% to 3% by weight of the metal, relative to a total weight of the particulates and the metal.

32. The protective varnish of claim 30, wherein the particulates have a particle size of less than 10 μm.

33. The protective varnish of claim 30, wherein the inorganic material is selected from zeolites or glasses.

34. The protective varnish of claim 28, wherein the metal comprises silver.

35. The protective varnish of claim 28, wherein the protective varnish comprises from 0.001% to 0.2% by weight of the metal, relative to a total weight of the protective varnish.

36. The protective varnish of claim 28, wherein the radiation hardenable compound is hardenable by UV radiation.

37. The protective varnish of claim 28, wherein the radiation hardenable compound comprises polyalkyl acrylate monomers, an unsaturated acrylic resin, or cycloaliphatic epoxide monomers.

38. The protective varnish of claim 37, further comprising a free-radical photoinitiator.

39. The protective varnish of claim 28, wherein the protective varnish comprises from 0.1% to 5.0% by weight of the IPBC, relative to a total weight of the protective varnish.

40. The protective varnish of claim 28, wherein the weight ratio of the metal to the iodopropynyl butylcarbamate ranges from 0.0007 to 0.01.

41. The protective varnish of claim 28, further comprising a fungicide selected from an isothiazoline derivative, an isothiazoline derivative, a zeolite, zinc, or a triclosan compound.

42. The protective varnish of claim 28, wherein the protective varnish is an overprint varnish.

43. An object comprising a protective coating formed from a protective varnish of claim 28.

44. A method of protecting an object, comprising:
coating a surface of the object with a protective varnish of claim 28; and
exposing the coated protective varnish to radiation to form a hardened varnish deposit.

45. A security document comprising a coating formed from a protective varnish of claim 28.

46. The security document of claim 46, wherein the security document comprises cellulosic fibres.

47. The security document of claim 46, wherein the security document comprises a plastic material.

48. Security document of claim 46, wherein the security document is a passport, a banknote, an identity card, a driving license, an access card, a loyalty card, a photocopying card, a canteen card, a playing card, a collection card, or a payment card.

49. The security document of claim 46, wherein the security document comprises a security element configured for authentication of the security document.

50. A method of protecting a security document, comprising:
coating a security document with a protective varnish according to claim 28; and
exposing the protective varnish to radiation to form a protective coating on the security document.

51. The method of claim 51, wherein the protective coating is formed on opposing sides of the security document.

52. The method of claim 51, wherein the protective coating is configured to reduce or prevent soiling of the security document.

53. The method of claim 51, wherein the protective coating is configured to impart antimicrobial properties to the security document.
